(19) United States
(12) Patent Application Publication
(10) Pub. No.: US 2010/0300296 A1
(43) Pub. Date: Dec. 2, 2010

(54) DEGASSER

(75) Inventor: Antonio Venturelli, Varese (IT)

Correspondence Address: Novak Druce + Quigg, LLP, 300 New Jersey Ave, NW, Fifth Floor, Washington, DC, 20001, US

(73) Assignee: TERMOCHIMICA IMPIANTI S.r.l., Gallarate (VA) (IT)

(21) Appl. No.: 12/745,010

(22) PCT Filed: Nov. 27, 2008
(86) PCT No.: PCT/EP08/66348

§ 371 Date: May 27, 2010

(30) Foreign Application Priority Data
Nov. 30, 2007 (IT) MI2007A002252

(51) Int. Cl. B01D 19/00

(52) U.S. Cl. 96/203

(57) ABSTRACT

Degasser including a shell and nozzles for spraying liquid into the shell, and plates within the shell to receive liquid sprayed by the nozzles. The plates disposed to enable running the liquid from upper plates to lower plates. The degasser including a port for steam entry into the shell and conveyor means for directing the steam between the plates. The steam is directed from the lower plates to the upper plates. The degasser including at least one first outlet to extract the degassed liquid from the degasser bottom and to enable a layer of degassed liquid to form on the container bottom when in use; and at least one second outlet to enable extracting a minimum part of the steam plus degassed gases from the shell interior. The conveyor means conveying entering steam to make it bubble through the layer of degassed liquid, to further reduce its dissolved gas concentration.

The present invention relates to a pressure degasser for treating boiler feed fluid. It relates in particular to a degasser of combined spray and tray type.

Known pressure degassers (commonly known merely as “degassers”) comprise a shell into which pressurized steam is fed. The pressurized steam comes into intimate contact with a plurality of fluid jets to be degassed, these being generated by suitable nozzles. The fluid then falls onto plates which are struck by a counter-current steam flow. The fluid ruins from the upper plates to the lower plates and the degassing process terminates. The fluid processed in this manner deposits on the bottom of the shell, from which it is withdrawn ready for use.

A drawback of known degassers is that the gas quantity dissolved in the is liquid on termination of a thermal degassing process is too high.

An object of the present invention is therefore to provide a degasser which improves the degree of fluid purification, so reducing the gas quantity dissolved in the fluid on termination of thermal degassing compared with traditional degassers.

These and other objects are attained by a degasser in accordance with the technical teachings of the accompanying claims.

Further characteristics and advantages of the invention will be apparent from the description of a preferred but non-exclusive embodiment of the degasser, illustrated by way of non-limiting example in the accompanying drawings, in which:

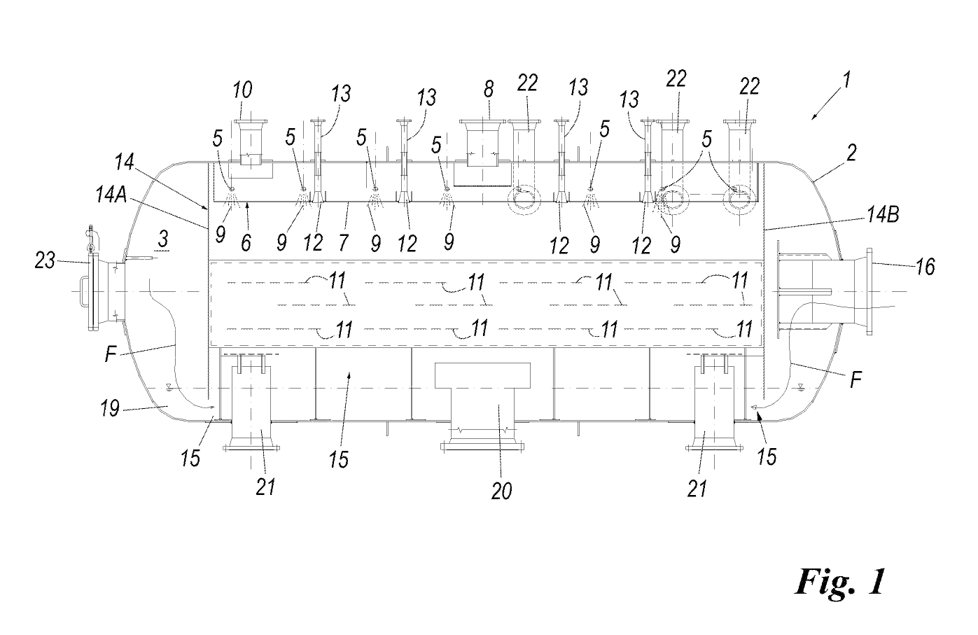

FIG. 1 is a schematic side view of a horizontal degasser of the present invention;

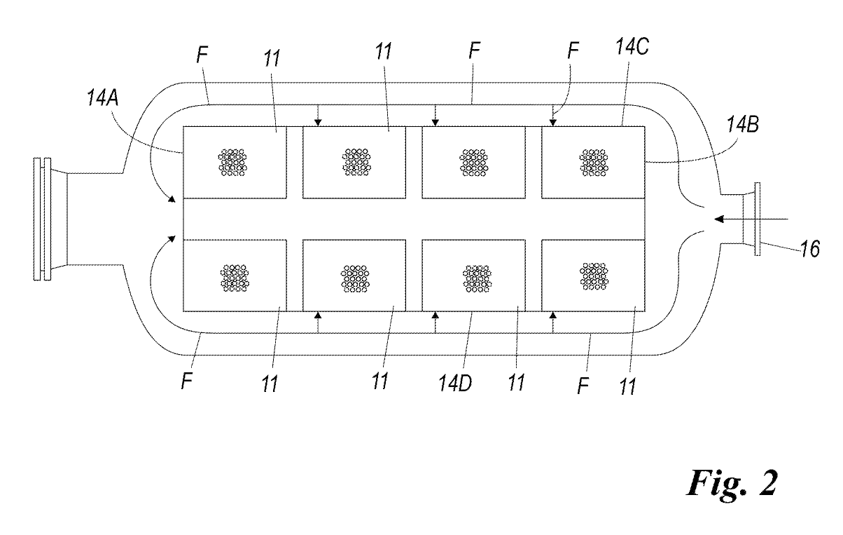

FIG. 2 is a schematic plan view of the degasser of FIG. 1, with some parts omitted for simplicity;

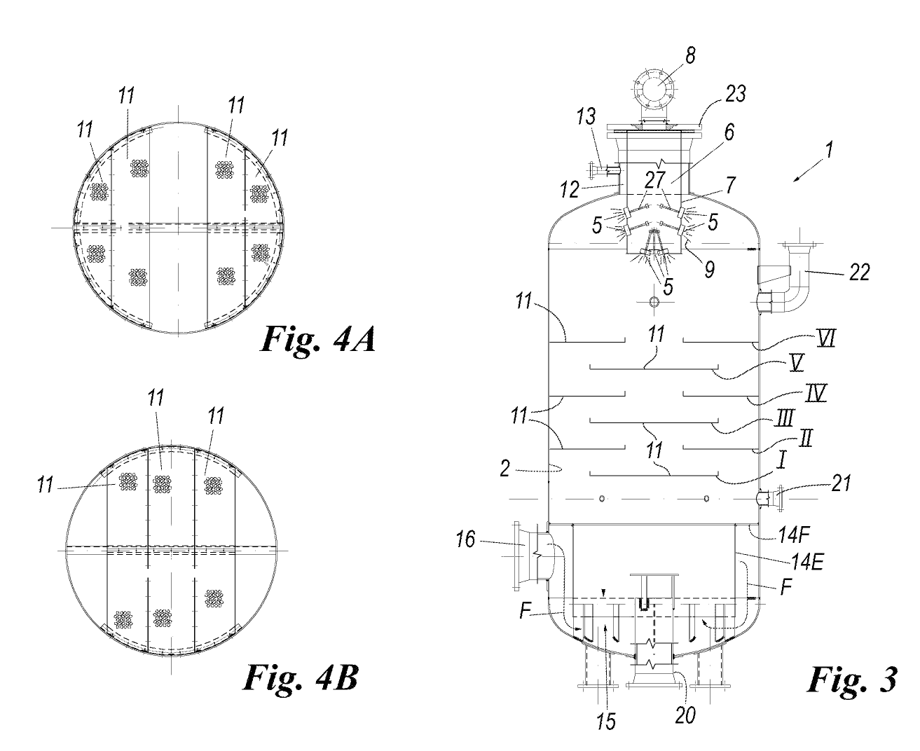

FIG. 3 is a schematic side view of a different embodiment of the degasser of the present invention (vertical degasser);

FIG. 4A is a schematic plan view of the degasser of FIG. 3, showing the arrangement of plates present at level II, IV and VI (and possible further even levels) of the degasser;

FIG. 4B is similar to FIG. 4A but shows the plates of levels I, III and V (and possible further odd levels);

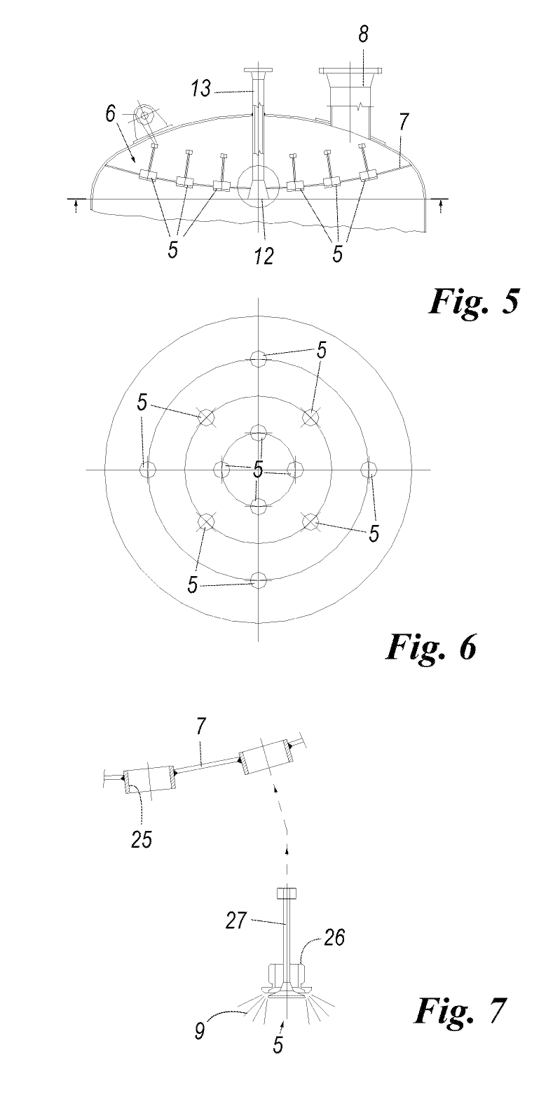

FIG. 5 is a schematic view of a different embodiment of the roof of a vertical degasser such as that of FIG. 3, showing a plurality of nozzles;

FIG. 6 is a schematic view showing the plan arrangement of the nozzles of FIG. 5;

FIG. 7 is a schematic view showing the mounting of the nozzles of

FIG. 5 and of the nozzles shown in FIG. 3;

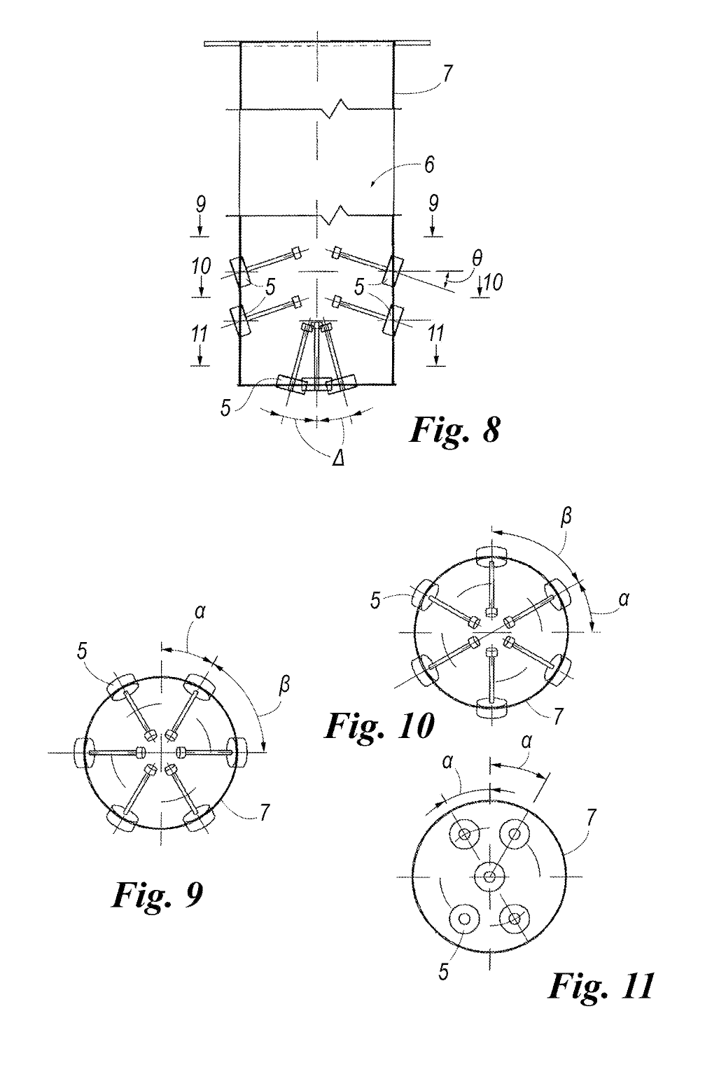

FIG. 8 represents schematically the chamber shown in FIG. 3, while

FIGS. 9, 10 and 11 represent sections taken on the lines 9-9, 10-10 and 11-11 of FIG. 8; in this group of Figures, a indicates angles of 30°, β is indicates angles of 60°, θ indicates angles of about 18°, and Δ indicates angles of 15°.

With reference to said figures, these show a degasser indicated overall by the reference numeral 1.

The degasser comprises a shell 2 constructed to maintain in its interior 3 a predetermined pressure greater than the external pressure.

Inside the shell 2 a plurality of nozzles 5 are present, fed with liquid to be degassed. The fluid is fed under pressure to a chamber 6 provided at the roof of the shell. This chamber 6 presents a surface 7 of interface with the shell interior. Said nozzles 5 are disposed on this surface 7 as explained hereinafter with reference to the vertical degasser of FIG. 3. The method for fixing these is in fact the same for both structures.

Each nozzle 5 is arranged to spray into the shell interior the fluid (preferably makeup and/or condensate water) to be degassed, fed to the chamber 6 through the inlet 8 and 10. Each nozzle 5 emits a jet forming a cone with an angle at its vertex between 55° and 65°, but preferably 60°.

In the surface of the chamber 6 apertures 12 are provided connected by pipes 13 to a steam and gas elimination system. These pipes together with the apertures 12 form outlets to enable gases removed from the fluid within the shell to be extracted.

A plurality of plates 11 are provided on several levels within the shell interior below the nozzles 5. The plates 11 are arranged to receive said liquid sprayed by the nozzles 5 and are particularly disposed such that the liquid can run from the upper plates to the lower plates. Advantageously, the plates 11 present a plurality of holes of diameter between 2.5 and 5 mm, preferably 3 mm or 4 mm. The holes are mutually positioned at the vertices of an equilateral triangle of side from 10 to 12 mm. Each plate can also perimetrally present a rim enabling a certain quantity of liquid to be accumulated and compelling the liquid to flow out towards the lower plates only via said holes, to create ideal capillary tubes of fluid which are struck in counter-current by the steam.

All the plates 11 are surrounded perimetrally by a housing 14 which is substantially compels the steam to pass through the plates 11 from the bottom downwards, after bubbling through the fluid in the bottom of the shell 2. In this respect the housing 14 presents vertical walls 14A, 14B, 14C, 14D which reach as far as the top of the shell and are welded to its roof. However, the housing presents a lower opening 15 enabling the steam to flow into its interior. Advantageously the opening is regulated such that the rate at which said steam passes through it is less than 15 m/s for horizontal degassers (10 m/s for vertical degassers), this preventing undesirable overflow phenomena.

In this respect, as visible in FIGS. 1 and 2, the container comprises a port 16 for steam entry into the shell 2. To reach the outlet apertures 12, the steam is obliged to take the path defined by the arrows F, and substantially to turn about the housing 14 and flow towards the opening 15 provided in the housing 14 in proximity to the bottom of the shell 2. Essentially, the steam flows between the inner wall of the shell and the housing 14.

Advantageously the shape of the walls of the housing 14 also obliges the steam to flow from the lower plates 11 to the upper plates, towards the apertures 12.

On the bottom of the shell 2 an outlet 20 is present to extract the degassed liquid from the bottom of said degasser. The outlet is provided such as to enable a layer 19 of degassed liquid to form on the container bottom when in use. The liquid level is indicated in FIGS. 1 and 3 by a dashed line. In contrast, the housing has the opening 15 completely immersed in the liquid present on the bottom of the container when in use. Hence the inflow of steam from the port 16 causes the steam to bubble through the liquid present on the bottom of the housing 2, which liquid hence becoming further degassed.

To complete the description, the shell presents one or more equalization pipes 21, safety valves 22 in the roof, and a closable aperture 23 for is inspection.

FIG. 3 shows a vertical degasser in which those parts functionally similar to those of the preceding embodiment are indicated by the same reference numerals and will not be further described.

In this embodiment the housing 14 does not surround the plates but is defined by a cylindrical wall 14E connected to the inner wall of the shell 2 and a closure ring 14F. Again in this case the housing presents an opening 15 which, when the degasser is operative, is immersed in the liquid on the bottom of the degasser. Hence again in this case the path of the steam fed by the port is obligatory. In this respect, before reaching the plates 11 it has to bubble through the liquid present on the bottom.

Advantageously, in both the preceding embodiments, the steam “rotates” about the housing before bubbling through the water, to hence recover the heat dispersed to the outside of the housing and recycle it into the housing itself. This results in a substantial advantage in terms of thermal yield. FIGS. 4A and 4B show the arrangement of the plates 11 and in particular the arrangement of levels I, III and V in FIG. 4B and II, IV and VI in

FIG. 4A. These levels are also shown in FIG. 3. This arrangement enables optimal heat transfer between the counter-current fluid and steam. FIGS. 6 and 8 show schematically the arrangement of the nozzles for the two types of vertical degasser. These are disposed in groups of elements equidistant along circles concentric to the shell axis in FIG. 6, and in parallel planes in FIG. 8.

As can be seen, the surface 7 of the chamber 6 presents a plurality of cylindrical housings 25, each receiving a nozzle 5. The nozzle is formed from a valve body 26 in which a stem 27 is housed. The valve body 26 presents a threaded cylindrical portion, which cooperates with a suitable thread of each cylindrical housing 25 to fix the nozzle in position. Various embodiments have been described but others can be conceived utilizing the same inventive concept.

1. A degasser comprising:
a shell in which a plurality of nozzles are present for spraying into the shell a liquid fed to them,
a plurality of plates being provided within the shell to receive said liquid sprayed by said nozzles, said plates being disposed such that the liquid is able to run from the upper plates to the lower plates,
a port being provided for steam entry into said shell, and conveyor means for directing said steam between said plates, the steam being directed from the lower plates to the upper plates,
at least one first outlet being provided to extract the degassed liquid from the bottom of said degasser, said first outlet being provided in such a manner as to enable a layer of degassed liquid to form on the bottom of said shell when in use, and
at least one second outlet to enable a minimum part of said steam plus gases to be extracted from the interior of said shell,
said conveyor means for conveying said entering steam to make the steam bubble through said layer of degassed liquid, to hence further reduce the degassed liquid's concentration of dissolved gases.

2. A degasser as claimed in claim 1, wherein said plates are disposed in a housing which perimetrally surrounds the plates, said housing comprising said nozzles and said second outlets a roof of the housing and comprising lowerly at least one opening for being, when in use, immersed in said layer of degassed liquid and arranged to receive the flow of said steam.

3. A degasser as claimed in claim 2, wherein the area of the opening is regulated such that the velocity of said steam through said opening is less than 10 m/s in the case of a vertical degasser and less than 15 m/s in the case of a horizontal degasser.

4. A degasser as claimed in claim 2, wherein the conveyor means are defined by inner surface of said shell and by outer surfaces of said housing.

5. A degasser as claimed in claim 1, wherein each of said plates presents a plurality of holes in the plate's surface.

6. A degasser as claimed in claim 5, wherein said holes have a diameter between 2.5 and 5 mm.

7. A degasser as claimed in claim 6, wherein said holes are mutually positioned at the vertices of an equilateral triangle of side either 10 or 12 mm.

8. A degasser as claimed in claim 5, wherein each plate presents a perimetral rim.

9. A degasser as claimed in claim 1, wherein the shell has a roof and the shell presents at the shell roof a chamber for feeding into the chamber said liquid to be degassed, said chamber being provided with a surface of interface with the interior of said shell in which a plurality of cylindrical housings are present, each receiving a nozzle presenting a valve body in which a stem is housed, said valve body presenting a threaded cylindrical portion arranged to cooperate with a suitable thread of the cylindrical housing to fix the nozzle in position.

10. A degasser as claimed in claim 1, wherein said nozzles are arranged to generate a cone with the cone's vertex angle between 55° and 65°.
